(19) United States
(12) Patent Application Publication
(10) Pub. No.: US 2004/0023036 A1
(43) Pub. Date: Feb. 5, 2004

(54) Manufacture of fascia boards

(75) Inventor: David Kulcik, Upper Saddle River, NJ (US)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Garden State Lumber Products Corporation, Oakland, NJ (US)

(21) Appl. No.: 10/212,194

(22) Filed: Aug. 5, 2002

(51) Int. Cl. B32B 27/38

(52) U.S. Cl. 428/413

(57) ABSTRACT

Factory-manufactured fascia boards are made by forming a fascia board to predetermined dimensions, coating the fascia board with a primer to form a primed fascia board, and coating the primed fascia board with paint to form a primed and painted fascia board. Because the boards are pre-primed and pre-painted, they may be installed on a structure without any priming or painting being required at the job site.

### BACKGROUND OF THE INVENTION

1. Field of the Invention

The present invention relates to finished factory-manufactured boards, and a method for the factory-manufacture of pre-primed, pre-painted fascia boards.

2. Description of the Prior Art

Fascia boards are horizontal structural pieces that cover the gap between the top of a wall and the eaves that project thereover. In the construction of homes and other buildings, fascia boards not only improve the appearance of the exterior of the buildings but also provide a measure of structural support and insulation.

Typically, fascia boards are made of wood such as pine. The pine boards are cut to size on site, attached to a building under construction (usually by being nailed in place), and then primed and painted. Because fascia boards are installed adjacent the roof area, they usually are far from the ground. This presents substantial difficulty in installing them as well as in priming and painting them. Because the boards are made of wood, they must be primed and painted in order to extend their useful life.

Although fascia boards made of primed and painted wood are most popular, other types of fascia boards are known. For example, U.S. Pat. No. 4,290,248 to Kemerer et al. discloses a process for forming thermoplastic products having surface textures. One of the products that can be formed using this process is a plastic fascia board. U.S. Pat. No. 6,235,349 to Grantham et al. discloses a method of pressure treating wood. The treated wood products may be used for exterior fascia material. In this particular method of treating wood, dye can be added to color the wood. U.S. Pat. No. 6,301,840 to Spinelli discloses a protective liner for covering a fascia board. The protective liner may be formed of plastic, and is suited for being painted or finished. The material from which the protective liner is formed may be painted, pre-colored, or tinted during manufacture.

As the foregoing description suggests, fascia boards made of materials other than primed and painted pine are available. However, primed and painted pine fascia boards remain a desirable product because they are relatively inexpensive, and because there are many pre-existing homes as well as new homes with wood siding and wood trim. Most fascia boards are white, and thus white paint is a more desirable coating for fascia boards than white dye, which has a more translucent appearance.

In view of the existing state of the art, there is a need for fascia boards that eliminate or substantially eliminate the inconvenience associated with priming and painting installed fascia boards. Desirably, any such fascia boards would be inexpensive and would match the appearance of existing primed and painted fascia boards.

### SUMMARY OF THE INVENTION

In response to the foregoing concerns, the present invention provides fascia boards that can be installed without the difficulty and inconvenience associated with priming and painting fascia boards after they have been installed. In the present invention, fascia boards are manufactured to predetermined dimensions and then are primed and painted at the factory. Fascia boards according to the invention preferably are formed from wood such as pine, although other materials such as plastics or plastic-impregnated wood also can be used.

By using fascia boards made according to the invention, the boards need only be cut to desired lengths on site and then installed. No on-site priming or painting is required. This results in considerable savings in the labor required to prime and paint already-installed fascia~boards. Furthermore, the quality of the finished boards can be higher than boards that are primed and painted after installation, because factory priming and painting techniques can produce more uniformity at much less expense.

The foregoing and other features and advantages of the invention will be apparent from an examination of the specification and claims that follow.

### DESCRIPTION OF THE PREFERRED EMBODIMENT

Fascia boards according to the invention preferably are formed from wood. The wood is finished to predetermined dimensions by techniques known to those skilled in the art. Suitable dimensions for fascia boards are known by those of ordinary skill in the art. The wood for forming fascia board according to the invention is selected from woods commonly used in woodworking and building. Examples of suitable woods include, but are not limited to, pine, oak, maple, ash, cherry, chestnut, walnut, poplar, elm, cypress, beech, birch, cedar, acacia, mahogany, rosewood, mesquite, hickory, adler, wenge, butternut, and lacewood.

After the fascia boards are finished by milling or other suitable finishing methods, a primer is applied to the fascia board. Suitable primers include, but are not limited to, latex, epoxy, acrylic, urethane-rich, zinc, oil-based, and water-based. One or more coats of primer may be applied to coat the fascia boards. The coating of primer may be applied using any technique known by those of ordinary skill in the art. Examples of suitable techniques include, but are not limited to, rolling, spraying, brushing, or dipping.

After the primer has been applied to the fascia boards, the boards are painted. Suitable paints include, but are not limited to, latex, acrylic, and oil-based. The paint may be white or any other color. However, white fascia boards are most common. The paint may be applied using any technique known by those of ordinary skill in the art. Examples of suitable techniques include, but are not limited to, rolling, spraying, brushing, or dipping. Coating the primed fascia boards with paint completes the manufacturing process. The boards now are ready for installation.

Because fascia boards manufactured according to the the present invention are pre-primed and pre-painted, they may be installed upon a structure without requiring painting at the job site or after installation upon the structure. Their ease of use makes them advantageous over prior art fascia boards.

Although the invention has been described in its preferred form with a certain degree of particularity, it will be understood that the present disclosure of the preferred embodiment has been made only by way of example, and that various changes may be resorted to without departing from the true spirit and scope of the invention as hereinafter claimed. It is intended that the patent shall cover, by suitable expression in the appended claims, whatever degree of patentable novelty exists in the invention disclosed.

1. A method for the factory-manufacture of finished fascia boards, comprising the steps of:
forming fascia boards finished to predetermined dimensions;
coating the fascia boards with a primer to form primed fascia boards; and
coating the primed fascia boards with paint to form primed and painted fascia boards.

2. The method of claim 1, wherein the fascia boards are formed from wood selected from the group consisting of pine, oak, maple, ash, cherry, chestnut, walnut, poplar, elm, cypress, beech, birch, cedar, acacia, mahogany, rosewood, mesquite, hickory, adler, wenge, butternut, and lacewood.

3. The method of claim 1, wherein the primer is selected from the group consisting of latex, epoxy, acrylic, urethane-rich, zinc, oil-based, and water-based.

4. The method of claim 1, wherein the paint is selected from the group consisting of latex, acrylic, and oil-based.

5. The method of claim 1, wherein the step of coating the fascia boards with a primer is accomplished by rolling, brushing, spraying, or dipping.

6. The method of claim 1, wherein the step of coating the fascia boards with paint is accomplished by rolling, brushing, spraying, or dipping.

7. A factory-manufactured fascia board, comprising:
a fascia board finished to predetermined dimensions;
one or more coatings coating of a primer covering the surfaces of the fascia board; and
one or more coatings of a paint covering the primed surfaces of the fascia board.

8. The factory-manufactured fascia board of claim 7, wherein the fascia board is formed from wood.

9. The factory-manufactured fascia board of claim 8, wherein the wood is selected from the group consisting of pine, oak, maple, ash, cherry, chestnut, walnut, poplar, elm, cypress, beech, birch, cedar, acacia, mahogany, rosewood, mesquite, hickory, adler, wenge, butternut, and lacewood.

10. The factory-manufactured fascia board of claim 7, wherein the primer is selected from the group consisting of latex, epoxy, acrylic, urethane-rich, zinc, oil-based, and water-based.

11. The factory-manufactured fascia board of claim 7, wherein the paint is selected from the group consisting of latex, acrylic, and oil-based.
